(19) United States
(12) Patent Application Publication
(10) Pub. No.: US 2012/0297944 A1
(43) Pub. Date: Nov. 29, 2012

(54) MACHINE FOR CUTTING WEB ROLLS

(75) Inventors: Romano Maddaleni, Bientina (IT); Mauro Gelli, Capannori (IT); Gioni Chiocchetti, Capannori (IT)

(73) Assignee: Fabio Perini S.p.A., i-55100 Lucca (IT)

(21) Appl. No.: 13/261,343

(22) PCT Filed: Dec. 23, 2010
(86) PCT No.: PCT/IT10/00512

§ 371 Date: Aug. 6, 2012

(30) Foreign Application Priority Data
Dec. 29, 2009 (IT) FI2009A000274

(51) Int. Cl. B26D 3/16; B26D 7/18; B26D 7/06

(52) U.S. Cl. 83/23; 83/401; 83/109; 83/437.2; 83/100; 83/409; 83/13

(57) ABSTRACT

The cutting machine includes at least one log feed channel; a cutting station along the feed channel, with at least one cutting blade for dividing each, log into individual rolls plus front and rear trims; a log feed device along the feed channel, including at least one rear member for pushing the logs to be cut, movable along the feed channel to push each log through the cutting station. The feed device also includes at least one front member for engaging with the log to be cut, arranged and controlled so as to engage frontally with each log, or series of rolls obtained after the log has been cut, for at least a part of its travel along the feed channel.

### TECHNICAL FIELD

The present invention relates to machines for paper converting and, more in particular, to cutting machines for dividing logs of paper or other wound web materials into individual rolls of smaller axial dimensions than the original log.

The invention also relates to a method for processing and particularly for cutting logs of wound web material, typically but not only paper, and tissue paper in particular, for the production of rolls of toilet paper, kitchen paper and the like.

### STATE OF THE ART

In the field of paper converting, and particularly in the production of tissue paper articles such as toilet paper, kitchen paper and the like, reels of paper with large axial and radial dimensions are generally produced, which are manufactured directly at the paper mill by means of continuous feeding of a sheet of cellulose fibre coming from a forming machine. These reels are subsequently unwound and rewound onto logs with a diametral dimension corresponding to the diametral dimension of the end product, but with axial dimensions corresponding to the axial dimension of the original reel, i.e. much larger than the axial dimension of the end product. Nowadays, reels and then logs of tissue paper are typically produced with an axial length of up to approximately 5 meters. These logs, which are obtained by rewinding the sheets unwound from one or more reels on so-called rewinding machines, must be cut into individual rolls with axial dimensions corresponding to the axial dimension of the end product. This cutting procedure is done using so-called cutting machines that also generate a front trim and a rear trim, in line with the front and rear of each log, which are subsequently discarded. Cutting machines of this type are described, for instance, in WO 2006/126229, WO2004/004989, U.S. Pat. No. 5,799,555 and other published patents.

In some known machines, such as the one described in U.S. Pat. No. 5,799,555 the log to be cut is fed in a continuous movement, preferably at a variable speed, along a feed channel and through a cutting station located along said feed channel. A disc-shaped blade with an orbital movement cuts a single log into rolls and front and rear trims. The cutting blade also has a forward and backwards reciprocating movement along the log feed channel, so that cutting of the log can take place without completely stopping the forward feed of the logs for each cutting cycle. However, to contain the extension of the blade reciprocating motion along the log feed channel, the logs advance at a variable speed or, to be more precise, at a lower speed during the cutting action and at a higher speed between one cutting action and the next.

This machine has considerably improved the production rate and the quality of the product obtained over previous machines, wherein it was necessary to stop the log to complete each cutting action with a blade that was only capable of an orbital motion, not of a forward and reverse reciprocating motion in the direction of the log feed channel. The need to cyclically vary the forward feed speed of the logs nonetheless has some residual drawbacks in the known machines, particularly the fact that the log, especially when it is large in size, tends to advance due to inertia when the speed of its forward movement is reduced. This gives rise to a risk of the rolls being cut in different lengths.

Moreover, the known cutting machines have difficulty in cutting the trims, which consist of “slices” or rings of logs of reduced axial length and consequently liable to becoming deformed during the cutting action due to the effect of the pressure exerted by the blade. This can give rise to the onset of defects in the first and last rolls obtained from the cutting of each log. In particular, that flat surfaces of the first and last rolls may not be parallel to one another. In an attempt to overcome this problem, U.S. Pat. No. 4,977,803 describes a cutting machine wherein the pusher, which pushes the logs to be cut through the cutting machine, comprises a trimming support that is inserted axially inside the tubular core of the log before it is cut. Each pusher is fitted with a member that slides the trim off the support. The rear trim is supported centrally during the cutting action, thereby improving the quality of the end product. This known machine nonetheless fails to overcome the problem of the poor quality of the cut coinciding with the front trim.

Downstream from the cutting machines, machinery for separating the trims from the flow of rolls is arranged. The latter are fed to the packaging machines, while the trims are recovered and recycled. Examples of devices (called “trimex”) for removing the trims from the flow of rolls are described in EP 0607761, EP1257486, EP1257397, WO03/1061122, and EP 1691958, among others. These devices are particularly bulky and they increase the length of the processing line, with clear drawbacks in terms of the plant installation, management needs and cost.

The trims that are removed and destined for recycling generally consist of a web material (typically tissue paper) wound around a core that is typically made of cardboard. The winding core is in the form of a ring made of a material different from the material wound around it. These two components (the wound material and the winding core, or ring) have to be separated before they can be recycled so that the cellulose fibres of the cardboard cannot contaminate the cellulose fibres destined to form a new sheet of paper, so the cardboard must not be mixed with the web material wound around it. WO2007/034528 describes a device that serves the purpose of separating the web material from the central winding core in the trims obtained after cutting the logs of tissue paper. The need to use such equipment entails a further increase in the bulk of the machinery and additional processing line costs. Another device serving the purpose of separating the tubular core from the web material wound thereon in trims obtained after cutting a log is described in EP-A-1582492.

### SUMMARY OF THE INVENTION

The present invention proposes a novel cutting machine that partially or entirely overcomes one or more of the drawbacks of the known machines.

According to one aspect, the invention concerns a cutting machine for cutting logs of web material into series of rolls plus a front trim and a rear trim, comprising: at least one log feed channel with a cutting station along said feed channel comprising least one cutting blade for dividing each log into individual rolls plus front and rear trims; a device for feeding the logs along said feed channel, comprising at least one rear member for pushing the logs to be cut, movable along said feed channel so as to push each log through said cutting station. Said feed device also comprises at least one front member for engaging the logs to be cut, arranged and controlled so as to frontally engage with each log, or the series of rolls obtained by cutting the log, over at least a part of the movement of the latter along said feed channel. A more even cut of the both front trims and all trims is thereby obtained thanks to the fact that the log is held both at the front and at the rear during the cutting of the trims.

In some embodiments, the front engaging member may remain engaged with the log during the cutting stage for part or all of the operation for cutting the log into individual rolls. This has the further advantage of reducing or eliminating the risk of any accidental, unwanted forward feed of the log due to inertia during the cutting stage, thereby ensuring more constant dimensions for the rolls.

In some embodiments of the invention, the front engaging members and rear pushing members are fitted with an element for retaining the front and rear trims being cut from each log, respectively, said retaining elements being arranged and designed so as to penetrate inside axial holes in said logs. A machine can thus be constructed wherein the trims remain engaged with the front engaging members and rear pushing members, and are thus removed from the forward feed path of the rolls, eliminating the need to provide other equipment, machines or systems for removing the trims from the flow of rolls downstream from the cutting machine.

Further advantageous features and embodiments of the cutting machine according to the invention are described in the attached dependent claims, which form an integral part of the present description.

According to another aspect, the invention relates to a method for dividing a log of web material into a plurality of rolls plus front and rear trims, comprising the following steps:
feeding a log along a feed channel and through a cutting station by a rear pushing member;
at said cutting station, dividing said log into a front trim, a series of rolls and a rear trim;
for at least a part of its feed travel along said feed channel, frontally engaging the log with a front engaging member, so that the log is made to advance gripped between said rear pushing member and said front engaging member.

Further advantageous features and embodiments of the method according to the invention are indicated in the attached dependent claims, which form an integral part of the present description.

### BRIEF DESCRIPTION OF THE DRAWINGS

The invention is easier to understand following the description given below with the attached drawings, which show non-limiting practical embodiments of the invention. More in particular, in the drawings:

FIG. 1 is a schematic side view of a cutting machine according to the invention;

FIGS. 2A to 2F show a working sequence of the cutting machine according to the invention in a first embodiment;

FIG. 3 shows a front view of a rear log pushing member or of a front log engaging member;

FIG. 4 shows a schematic view from above of a pair of flexible members for advancing the rear pushing members or the front engaging members along a feed channel of the machine according to the invention;

FIG. 5 shows a schematic side view of another embodiment of the cutting machine according to the invention;

FIGS. 6A to 6K schematically show a sequence of the operations for separating the web material from the winding core in the trims;

FIGS. 7A to 7F schematically show a side view of the sequence for the removal of a trim, or ring of winding core, from the rear pushing or front engaging members;

FIGS. 8A to 8M show a sequence of operations of a cutting machine in a modified embodiment;

FIGS. 9A to 9F show a working sequence of a cutting machine in another modified embodiment; and

FIGS. 10A and 10B show two different positions in which the cutting machine can be adjusted as a function of the diametral dimension of the log to be cut.

### DETAILED DESCRIPTION OF EMBODIMENTS OF THE INVENTION

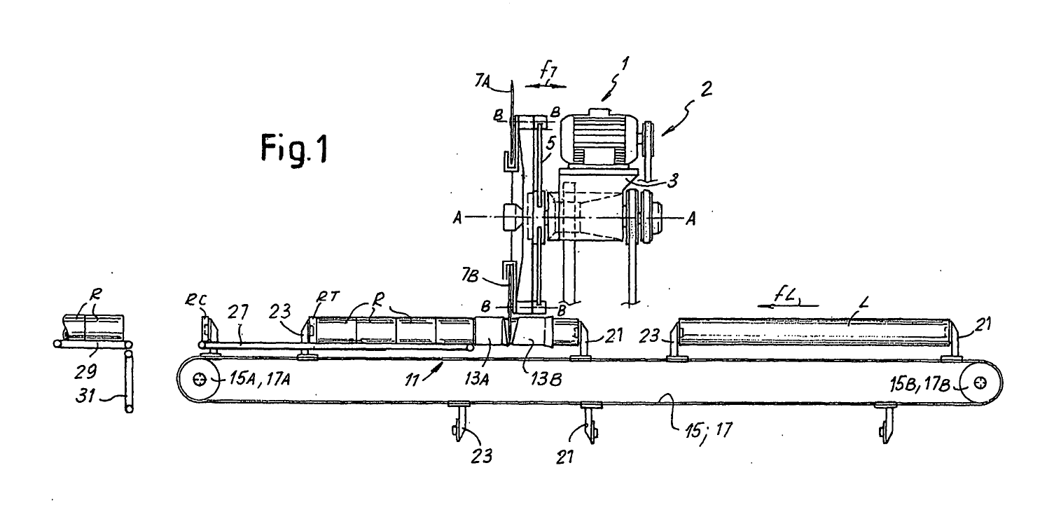

FIG. 1 schematically shows a cutting machine in its essential parts. Said machine has a cutting head 1 with a structure 3 on which a rotating plate 5 is mounted, where A-A indicates the rotation axis of the plate. The plate can support one or more disc-shaped cutting blades. In the example, there are two cutting blades 7A and 7B, for which B-B indicates the axes of rotation. The disc-shaped blades 7A, 7B work alternately, in the sense that as the plate 5 rotates around the axis A-A, the blades 7A, 7B cut a roll sequentially, first one and then the other, from a log being fed through the machine, in the manner described below. It is important to understand that the machine may also have a different number of disc-shaped cutting blades, e.g. only one blade or three or even more blades on the same plate 5. In some embodiments, the blades can be in pairs and coaxial, e.g. for cutting two consecutive rolls in a single cutting stage, all as known to those skilled in the art.

In some embodiments, the disc-shaped cutting blade(s) 7A, 7B have a reciprocating movement in the direction of the double arrow f7 so that they can follow the log L as it advances in the direction of the arrow fL, and the log L therefore does not need to stop completely in order to be cut. The movement can be imparted to each disc-shaped cutting blade 7A, 7B, or to the whole plate 5. The way in which this movement is achieved is in itself known and is not described in more detail herein.

One or more channels for feeding the logs L extend through the cutting machine globally indicated by the numeral 2. Typically, there may be from one to five channels lying parallel to one another, only one of which is shown in the schematic side view of FIG. 1. The channels pass through a cutting station 11 in the cutting machine 2. In a known manner, for each log feed channel L, the cutting station 11 includes a through seat, through which the logs L to be cut are pushed, consisting of curved sheets that form friction and sliding surfaces for holding the log laterally during the cutting process. The sheets are divided into two parts, indicated as 13A and 13B, to leave a space between them for the passage of the cutting blades 7A, 7B. This arrangement is in itself known and is not described in more detail herein.

Each log feed channel L through the cutting machine is associated with two continuous flexible members, shown in a top view in FIG. 4, where they are indicated as 15 and 17. These flexible members 15 and 17 may be belts, chains or the like. Each of them is entrained around respective wheels, indicated as 15A and 15B for the flexible member 15, and as 17A, 17B for the flexible member 17. The numerals 15C and 17C (FIG. 4) schematically indicate two independent motors, connected to a central control unit 18, for controlling the forward movement of the flexible members 15 and 17.

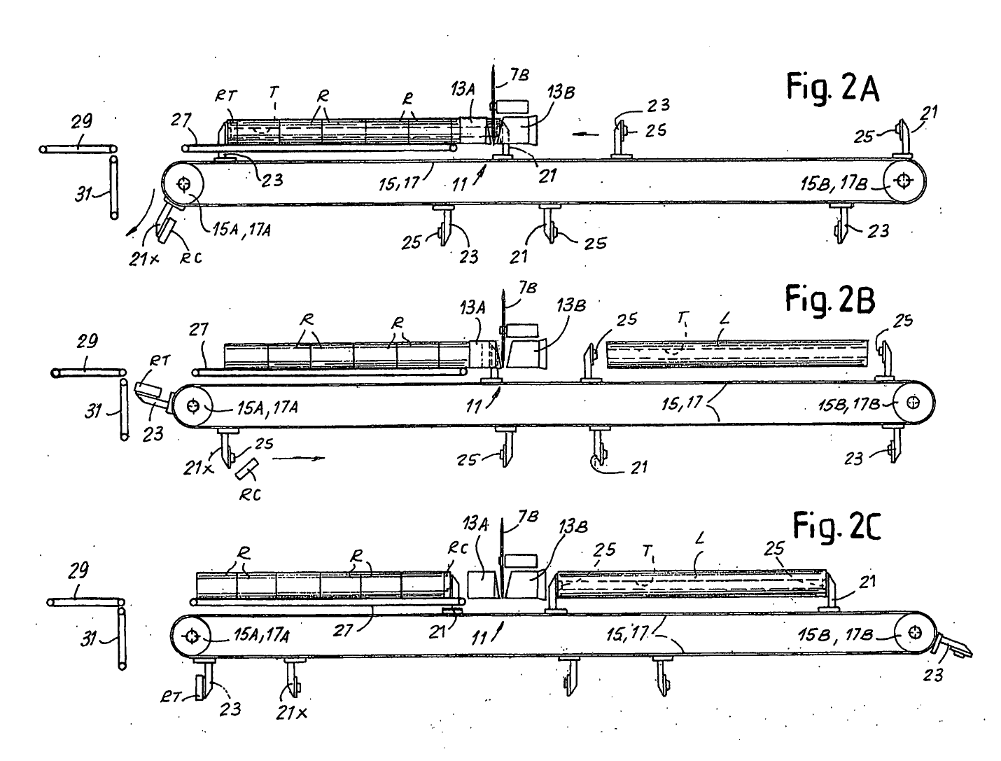

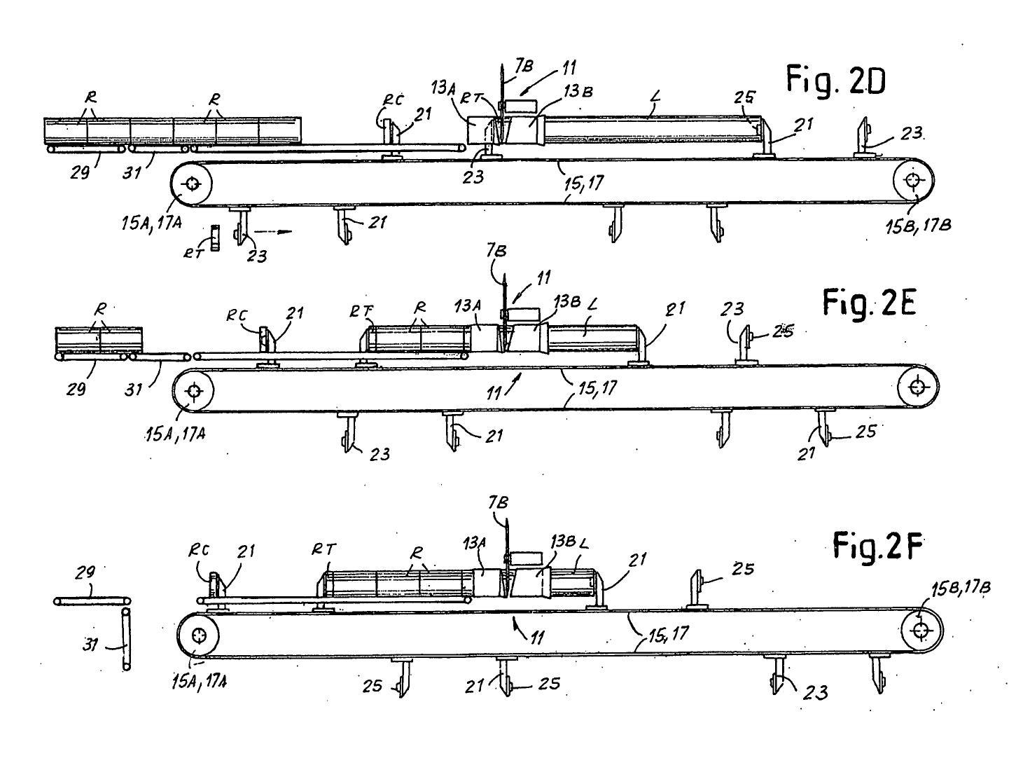

In the side view in FIGS. 2A-2F, the two flexible members 15, 17 overlap with one another so only one of them is visible in the figure; and the guiding wheels 15A, 15B and 17A, 17B are likewise overlapping.

Rear pushing members 21 are mounted on the flexible member 15, which serve to push the logs L through the cutting machine 2, along respective feed channels. In the example shown, there are four rear pushing members 21 for each channel, but it is important to understand that there may be a number thereof different from the one shown in the example.

Front engaging members 23 are mounted on the flexible member 17, which (as explained later on) engage frontally with the logs to be cut, or with the series of rolls and trims obtained by cutting individual logs. There are as many front engaging members 23 as there are rear pushing members 21.

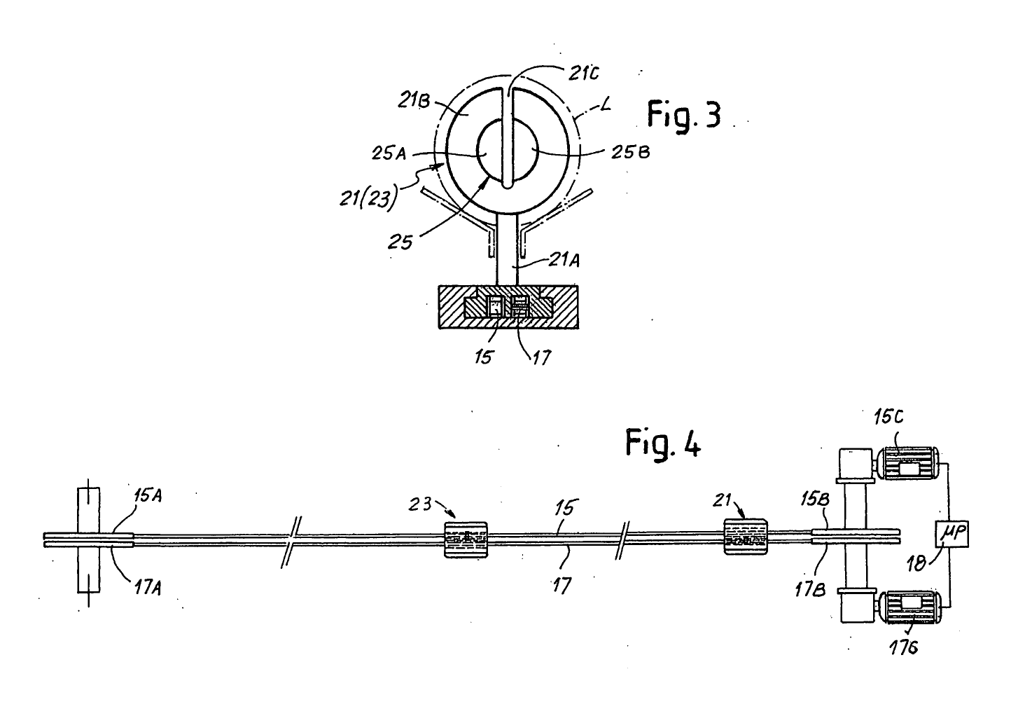

FIG. 3 shows a front view of one of the members 21, 23, which may be substantially identical to one another. Hereinafter, the element illustrated in FIG. 3 will be referred to as the rear pushing member, on the understanding that the front engaging member 23 may be shaped in the same way. The rear pushing member 21 comprises a stem 21A, by means of which it engages with the respective continuous flexible member 15. The stem 21A ends with a head 21B that is partially divided into two parts by a slot or cut 21C, which extends diametrically over a length that is preferably shorter than the diameter of the head 21B. An element 25 for retaining the trims is located on the head 21B. Each retaining element 25 consists of two portions 25A, 25B, separated by the cut 21C for the purposes explained below. The retaining elements 25A, 25B may be expansible elements, e.g. elastic elements with a truncated cone shape as shown in FIGS. 2A-2F. Each retaining element may, for instance, have elastically compressed side fins that tend to expand radially, and that retract as a result of the interaction between the truncated cone shaped surface of the retaining element 25 and the tubular core of the trim, or of the log L, with which the element 25 engages.

As shown in particular in the sequence of FIGS. 2A-2F, the continuous flexible members 15, 17 extend downstream the cutting station 11 (with respect to the feed direction of the logs L) over a length corresponding to at least the maximum length of the logs L that can be processed by the cutting machine 2, for purposes described below. In the terminal part of the feed channel for each log L, downstream from the cutting station 11, there is preferably a feed conveyor 27 extending between the cutting station 11 and the feed channel outlet. In some embodiments, downstream from the feed channel there is an unloading conveyor 29, that is separate from the conveyor 27. Between the conveyor 27 and the conveyor 29, there is a movable transfer member 31, which can take two different positions as shown in FIGS. 2A, 2B, 2C, 2F, and in FIGS. 2D and 2E, respectively, for purposes explained below.

The operation of the above-described machine is now described with reference to the sequence of FIGS. 2A-2F. Referring initially to FIG. 2A, a pair of rear pushing member and front engaging member 21, 23 come to be opposite one another in the area upstream from the cutting station 11, at a distance slightly greater than the length of the log L to be cut. A new log to be cut must be inserted in this position, as shown in FIG. 2B, where said log is indicated by the letter L. While the pair of rear pushing and front engaging members 21, 23 is upstream from the cutting station 11, a second pair of rear pushing member and front engaging member 21, 23 is in the area of the cutting station 11 and downstream therefrom and, engaged between the two members 21, 23, there is a log previously inserted in the machine and already almost completely divided into rolls R plus front and rear trims RT, RC.

In the arrangement shown in FIG. 2A, between the rear pushing member 21 in the cutting station 11 and the front engaging member 23 downstream from the cutting station 11 (with respect to the log feed direction fL), there is a series of rolls R cut by the blade(s) 7A, 7B of the cutting machine 2, at the beginning and end of which there are a front trim RT and a rear trim RC, respectively. At this point the latter is still inside the cutting station 11. The front trim RT is in contact with the front engaging member 23 and engages with the retaining element 25 on the latter. The rear trim RC engages with the retaining element 25 attached to the rear pushing member 21 temporarily occupying the cutting station 11.

Each retaining element 25 is inserted inside the tubular core T on which the log L is wound and that is cut together with said log into as many lengths as there are rolls R, plus the trims RT, RC. As mentioned previously, the displacement of the logs, and consequently of the rolls, in the cutting stage may be in an intermittent or continuous movement, preferably at a variable speed. In this displacement, and throughout the cutting stage, the log L and the series of rolls R plus the front and rear trims RT, RC remain engaged between the front engaging member 23 and the rear pushing member 21, which advance while maintaining a constant distance from one another, corresponding to the total length of the log L being cut. The forward feed is controlled by the two motors 15C, 17C under the control of the programmable electronic unit 18.

Again with reference to FIG. 2A, downstream from the front engaging member 23 (with respect to the log feed direction fL along the feed channel), there is a further rear pushing member, indicated as 21X, that rotates around the axis of rotation of the wheels 15A, 17A to move out of the active forward feed path in the direction fL and into a return path underneath the feed channel for the logs L. The passage of the rear pushing member 21X from the feed channel to the return path is enabled by the fact that the movable transfer member 31 (e.g. a conveyor belt) has been rotated downwards to leave a gap between the unloading conveyor 29 and the feed conveyor 27. In other embodiments (not shown) the movable transfer member 31 may be temporarily removed from the forward feed path by means of an upward instead of a downward rotatory movement, in order to allow more time for the passage of the trims. This does not rule out other possible mechanisms and movements designed to cause the temporary withdrawal of the movable transfer member 31.

In FIG. 2B the cutting of the last rear trim RC of the log L has been completed by the blade 7. A new log L has been inserted in the feed channel between the rear pushing member 21 and the front engaging member 23 shown upstream from the cutting station 11; again in FIG. 2B. The front engaging member 23, formerly engaged with the front trim RT of the log just cut in FIG. 2A, has now begun its downward rotatory movement around the axis of the wheels 15A, 17A so as to be inserted in the return path, passing through the space left free by the movable transfer member 31. The rear pushing member 21X that was previously in this position is now in the return path. The front trim RT of the log just cut remains engaged with the retaining element 25 of the front engaging member 23 and follows the latter in its rotation towards the return path under the feed channel for the logs L.

The next FIGS. 2C and 2D show how the series of cut rolls R is pushed by the rear pushing member 21 towards the unloading conveyor 29, to enable the transfer of the rolls R from the feed channel of the cutting machine 2 to the unloading conveyor 29. When the front engaging member 23 has reached its lower position (FIG. 2C) in the return path, the movable transfer member 31 can be restored to the horizontal position (FIG. 2D) to form a continuous forward feed path in combination with the unloading conveyor 29 and the feed conveyor 27.

The conveyors 29, 31 and 27 may have a variable speed control in order to separate the rolls R from the rear pushing member 21, which advances at a lower speed, while keeping the rear trim RC engaged with the retaining element 25 of the rear pushing member 21, as shown in FIG. 2D. The series of rolls R thus reaches the unloading conveyor 29 after the front trim RT and the rear trim RC have been removed by keeping them engaged with the retaining elements 25 of the front engaging and rear pushing members 23 and 21, respectively.

FIG. 2C shows how the next pair of members 21, 23 advances towards the cutting station 11, holding the new log L to be cut between them.

In FIG. 2D, the front trim RT of the new log L has already been cut and, between the curved sheets of the through seat 13A, 13B of the cutting station 11, the front portion of the log L that will subsequently be cut to form the first roll of the new series is advancing. Along the return path there is the front engaging member 23 from which the front trim RT has been removed, while the member 23 advances in the direction of the arrow indicated in the figure towards the area where it will be used to engage with a new log L and advance therewith through the cutting station 11. The rear and front trims RC, RT are separated from the retaining elements 25 on the rear pushing and front engaging members 21, 23 as explained later on.

FIG. 2E shows how, after pushing the previous log L, the rear pushing member 21 advances towards the terminal part of the feed channel and reaches the guiding wheels 15A, 17A (FIG. 2F) when the rolls R obtained by cutting the previous log have all been transferred onto the unloading conveyor 29, so that the movable transfer member 31 can be lowered (or raised) again to enable the passage of the rear pushing member 21 from the forward feed path along the feed channel for the logs L and rolls R towards the return path underneath.

The forward feed of the rear pushing member 21, carrying the previously cut rear trim RC, is controlled as a function of the forward feed movement of the next log L, which is pushed by the next rear pushing member 21. There is therefore a constraint on the displacement of the rear pushing member 21 that was used to push the previous log, which cannot move away from the log L during the cutting stage in FIGS. 2D, 2E and 2F, and likewise the front engaging member 23 that released the previous log cannot move away from the next front engaging member holding the log L during the cutting stage in FIGS. 2D, 2E and 2F. At this point, therefore, the two continuous flexible members 15, 17 advance synchronously, maintaining the reciprocal distances between the rear pushing members and the front engaging members. The reciprocal separation of the rear pushing members 21 from the front engaging members 23 occurs in the next stage, which coincides with the situation shown in FIG. 2B, after the cutting of a log being processed, with the separation of the front engaging member 23 from the log L that has just been cut.

It is clear from the above description that each log L is held between a pair of front engaging and rear pushing members 23, 21, respectively, and remains engaged therebetween throughout the process, i.e. all the time required to cut the log L into rolls R plus front and rear trims RT, RC. This solution has two advantages. First, it avoids any accidental forward displacement of the log L due to inertia during the cutting stage and its accidental detachment from the pushing member 21, said detachment being prevented by the presence of the corresponding front engaging member 23. This guarantees a uniform axial dimension for the rolls R obtained by cutting the log L.

In addition, since the respective retaining element 25 is kept inserted inside the tubular core T of the log L during the cutting of both the front trim RT and the rear trim RC, the material forming these two trims is supported at the centre, and this enables a more precise cutting action without any deformation of the material, thereby also achieving a better quality of the first and last rolls of each series.

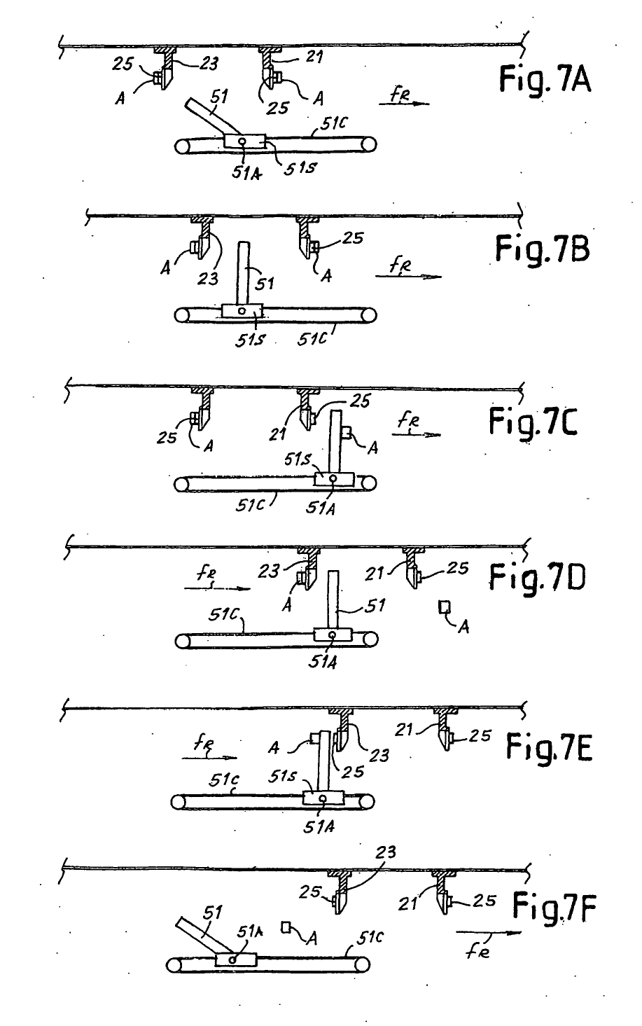

In the embodiment shown, moreover, the front and rear trims RT, RC remain engaged with the respective retaining elements 25, so said trims RT and RC are removed from the flow of rolls passing from the feed channel of the cutting machine 2 to the unloading conveyor 29, so that only the rolls intended for packaging remain on the latter. This makes any presence of a trims eliminator downstream from the cutting machine 2 superfluous. The trims are then recovered directly in the area underneath the cutting station 11. The trims are detached from the rear pushing and front engaging members 21, 23 as explained later on, with reference to the sequence in FIGS. 7A to 7F.

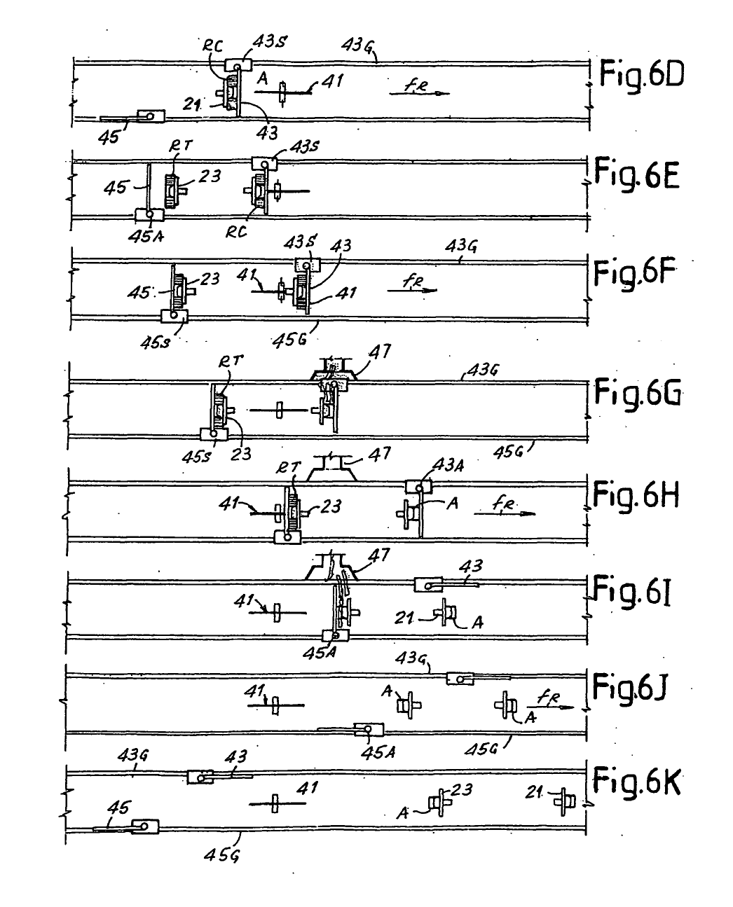

A system can be provided along the return path of the rear pushing and front engaging members 21, 23, underneath the feed channel for the logs L and rolls R, for separating the wound web material from the tubular winding core T of each front trim RT or rear trim RC, in order to simplify the recovery and recycling of these materials. The sequence of FIGS. 6A to 6K shows a possible arrangement and a possible mode of operation of such a separator system.

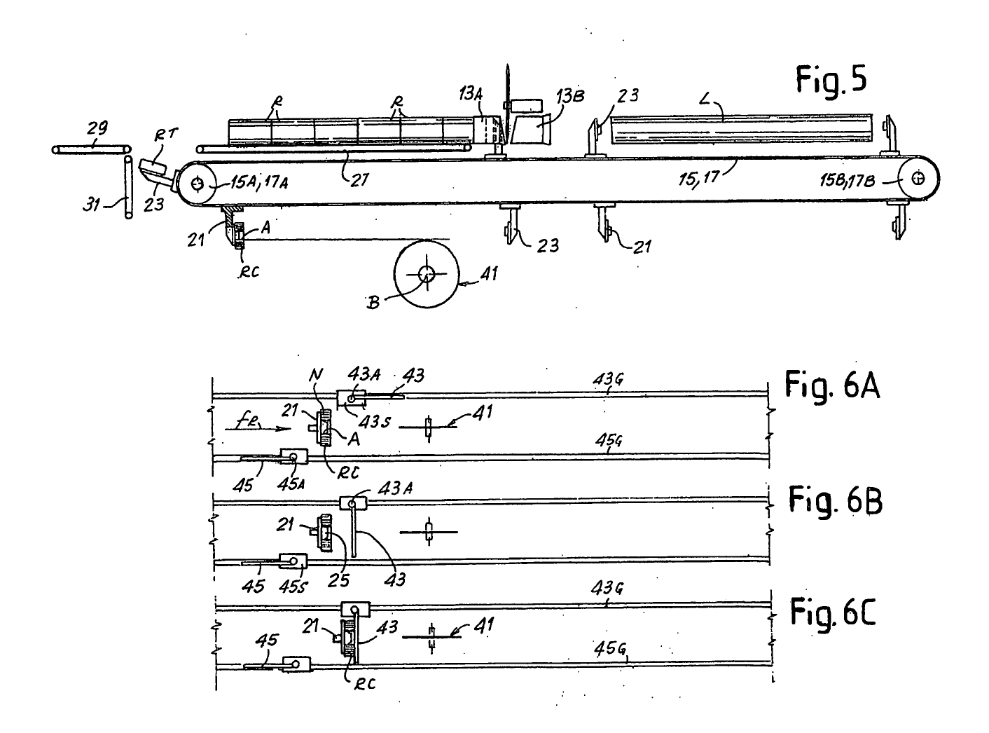

FIG. 5 shows a configuration of the machine substantially equivalent to that of FIG. 2A to 2F, with the sole addition of a disc-shaped blade 41 rotating around an axis B orthogonal to the forward feed direction of the logs L, and located underneath the return branch of the continuous flexible members 15, 17. The disc-shaped blade 41 is located at a distance from the return branch of the continuous flexible members 15, 17 so that said blade penetrates inside the cut 21C provided in each head 21B of the rear pushing members 21 and of the corresponding front engaging members 23. When the rear pushing members 21 and front engaging members 23 advance along the return path of the flexible members 15, 17, the blade 41 thus cuts the turns of web material wound on each front and rear trim. The distance between the axis of rotation B of the blade 41 in relation to the retaining element 25 of the trims, and the diameter of the blade 41 are chosen so that the blade 41 preferably only cuts the web material, and not the cardboard forming the ring-shaped slice of tubular winding core T inside each front trim RT and rear trim RC.

Downstream from the blade 41, each front trim RT and rear trim RC will thus have a cut passing through the full thickness of the web material wound in a spiral around the cardboard core, while the core remains substantially intact.

To facilitate the cutting action of the blade 41, the front and rear trims are retained by battens 43, 45, which advance along the return path of the front engaging and rear pushing members 23, 21 so that the action of the blade 41 does not make the front trim RT and rear trim RC become detached from the respective retaining elements 25. The operation of these members is illustrated in the sequence of FIGS. 6A to 6K. These figures schematically show a top view of the members lying under the return branch of the flexible members 15 and 17. The sequence in FIGS. 6A-6K shows a rear pushing member 21 and a front engaging member 23, each of which carries a respective rear trim RC and front trim RT. Each trim is formed of web material N wound in a spiral around a ring A consisting of a slice of the tubular core T on which the log L was wound before it was divided into rolls and trims R, RT, RC. The return movement of the rear pushing and front engaging members 21, 23 is represented by the arrow fR in the sequence of FIGS. 6A-6K.

The operation is as follows.

In FIG. 6A, the rear pushing member 21, which has come out of the log feed channel and has been inserted in the return path, comes to be upstream (with respect to the feed direction fR along the return path) from the blade 41, and the retaining element 25 of said member engages with the rear trim RC. The battens 43 and 45 are upstream from the blade 41. FIG. 6B shows the stage where the batten 43 is rotated through approximately 90° around the axis 43A so that it comes to be facing the rear pushing member 21. In FIG. 6C the rear pushing member 21 is moved forward until it brings the rear trim RC up against the batten 43. The rear pushing member 21 and the batten 43 begin to advance together towards the blade 41, holding the rear trim RC between them (FIG. 6D). For this purpose, the batten 43 is mounted, for instance, on a carriage 43S that is movable along a guide 43G. The displacement may be controlled by a system of belts, a threaded bar, or in any other manner, and driven by an electronically-controlled electric motor (not shown) interfaced with the programmable control unit 18 (FIG. 4).

Continuing to advance in the direction of the arrow fR, the set formed by the rear pushing member 21 and the batten 43 with the rear trim RC held between them begins to intersect the blade 41; thanks to the way in which the blade is arranged and sized, it cuts through the thickness of the web material N without cutting the core A, penetrating through the slot or cut 21C in the rear pushing member 21 and a corresponding slot in the batten 43 (FIG. 6E).

FIG. 6F shows the final stage of this cutting operation, with the trim RC that emerges beyond the blade 41, advancing in the direction of the arrow fR. Downstream from the blade 41 there are suction means, e.g. two lateral extractor hoods 47, only shown in FIG. 6G for the sake of the simplicity of the drawings. These hoods (or, alternatively, just one hood) take up the web material N cut by the blade 41, leaving only the ring-shaped slice A of tubular core T on the retaining element 25.

FIGS. 6E, 6F and 6G also show the next front engaging member 23 entering the return path carrying the front trim RT. In FIG. 6E the batten 45 has been rotated through 90° around the axis 45A, so that it comes in front of the trim RT; and in FIG. 6F the batten 45 has moved forward at a higher speed than the forward feed speed of the front engaging member 23 so as to keep the front trim RT between the batten 45 and the front engaging member 23. The batten 45 may be mounted, for instance, on a carriage 45S that is movable along a guide 45G, controlled by a motor (not shown) in much the same way as the batten 43 and the carriage 43S.

FIG. 6H shows the rear pushing member 21 that, together with the batten 43, has moved away from the blade 41, while the front engaging member 23 and the batten 45 come into line with the blade 41, which cuts the web material N on the front trim RT. The cut material N is again taken up by the hoods 47.

In FIG. 6I the batten 43 has stopped moving forward in the direction of the arrow fR and has been rotated through 90° to bring it once again into a position parallel to the feed direction fR, while the front engaging member 23 is downstream from the blade 41 and has been freed of the web material N cut by the blade 41.

In FIG. 6J the rear batten 45 has been rotated through 90° so that it can return, together with the batten 43, to its initial position (FIG. 6K). The rear pushing member 21 and the front engaging member 23 are downstream from the blade 41 and they move towards the end of the return path with the ring-shaped slices A of the tubular core T still attached to the retaining elements 25.

To detach these ring-shaped slices A there may be a mechanical system downstream from the blade 41, along the return path of the members 21 and 23, such as the one schematically shown in the sequence of FIGS. 7A to 7F, which also illustrate how it works. In a side view, these figures show the rear pushing and front engaging members 21, 23 advancing in the direction of the arrow fR along the return path, with the ring-shaped slices A of tubular core T attached to the retaining elements 25. Along the return path there is an additional movable batten 51 swinging around a crosswise horizontal axis 51A. The batten 51 can be brought by a movable carriage 51S along a horizontal guide and connected, for instance, to a belt 51C driven by an electric motor (not shown), controlled by an electronically-controlled programmable unit 18 (FIG. 4).

In FIG. 7A the batten 51 is withdrawn with respect to the path along which the members 21 and 23 advance. The rear pushing member 21 is passing on a level with the batten 51 underneath. In FIG. 7B the rear pushing member 21 has moved beyond the hinge of the axis 51A of the movable batten 51 and the latter can move into an upright position and begin to advance at a faster rate than the forward feed speed of the rear pushing member 21 in the direction fR so as to push the cardboard ring A away from the retaining element 25 as the latter passes through the cut 21C in the rear pushing member 21.

The batten 51 can stay in the position reached in FIG. 7D while the front engaging member 23 continues to advance (FIG. 7E), so as to pass along the outside of the batten 51, which consequently slides the cardboard ring A off the retaining element 25 associated with the front engaging member 23, making it drop down into a collection area where the cardboard ring A removed from the rear pushing member 21 has also been collected. Then the batten 51 can return to its initial position as shown in FIG. 7F, by withdrawing and swinging downwards around the axis 51A.

Essentially, therefore, the members 41-51 can be used to separate the web material N from the cardboard A in the trim, unloading and recovering them in two distinct positions along the return path of the rear pushing member 21 and of the front engaging member 23, so as to facilitate the recovery of the material for subsequent recycling.

In less advantageous but simpler embodiments, the trims can be removed from the rear pushing and front engaging members 21, 23 without separating the web material N from the cardboard A, leaving this operation to a separate machine of known type, for instance, or simply discarding the trims, or recovering them without separating the cardboard fibres from the paper fibres, e.g. to produce a lower-quality recycled material. In this case, there will be no blade 41, or battens 43, 45 along the return path of the rear pushing and front engaging members 21, 23; there will only by the batten 51 that will operate as shown in FIGS. 7A-7F, but taking action on whole trims instead of just the cardboard rings attached to the retaining elements 25.

This does not rule out the possibility of other systems being used to remove the trims from the retaining elements 25, e.g. means that take effect on the outside of the retaining element 25, or extractor systems that exert a suction pressure on the front or rear members 21, 23 sufficient to slide the trims off the retaining elements 25. In further embodiments, to facilitate the removal of the trims from the retaining elements 25, the latter may also be controlled by a mechanical opening and closing, i.e. radially expanding and retracting, system designed to engage with the trims and separate them from the rolls R, and then release the trims, making it is easier for them to drop due to the effect of gravity when the members 21, 23 rotate around the wheels 15A, 17A and 15B, 17B. In this case, the trims can be removed simply by dropping them, without the need to take action thereon with other means.

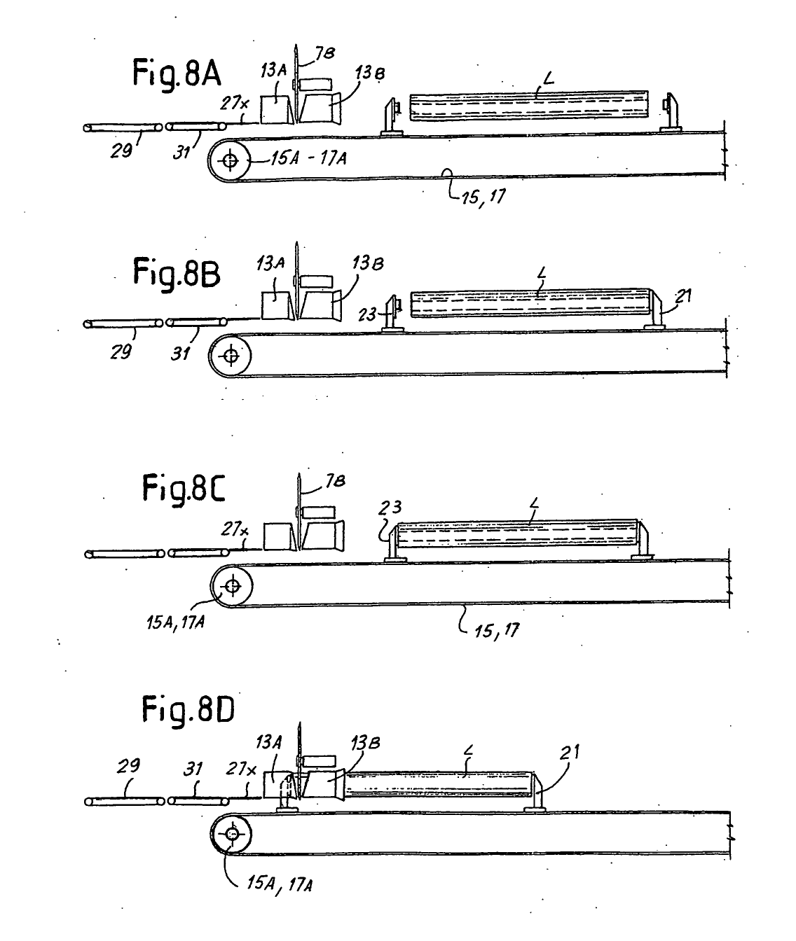

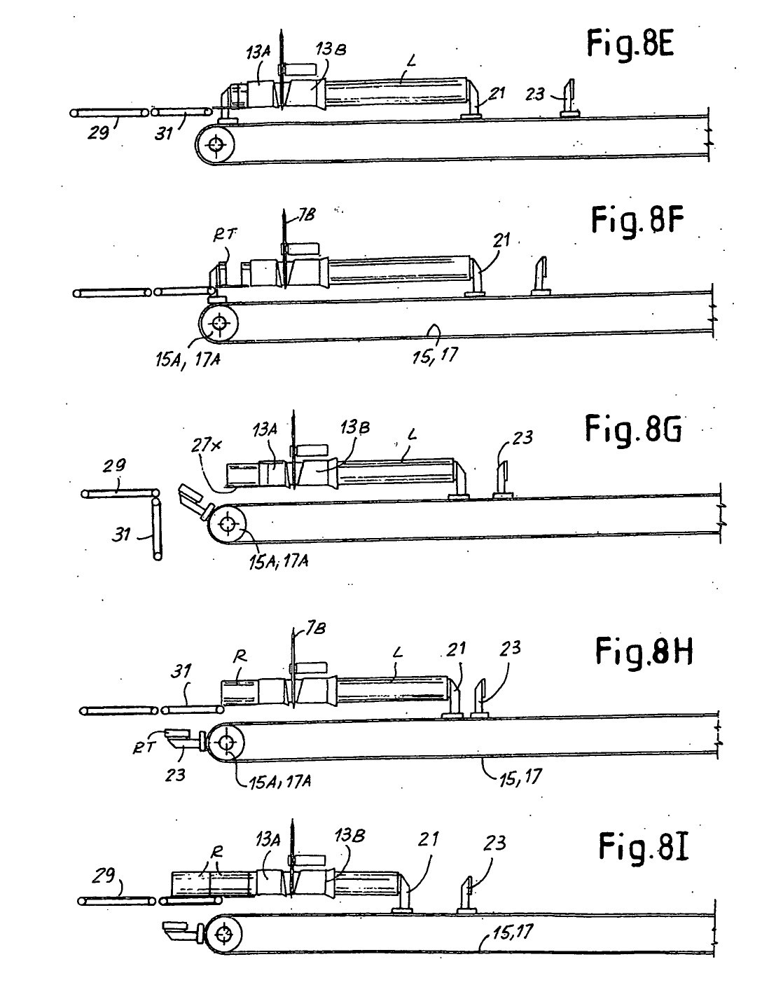

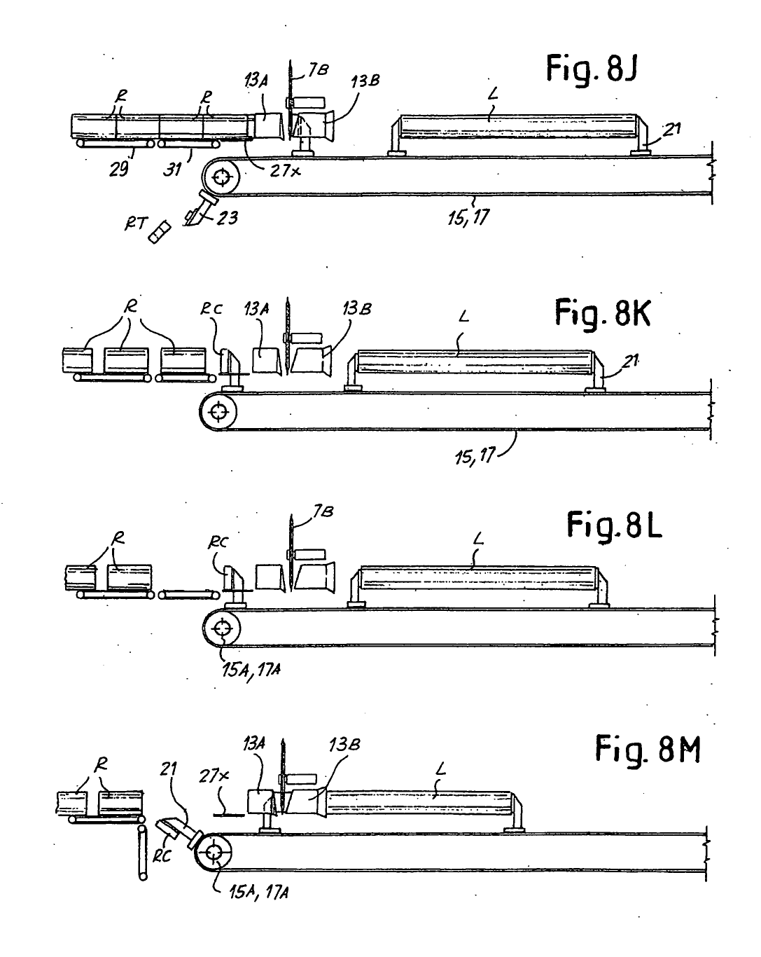

Here above a system has been described, wherein the rear pushing and front engaging members 21, 23 are used to control each log L by engaging it between said members throughout the log cutting step, i.e. the step of cutting the log into rolls and trims, affording the above-mentioned advantages. Some of the above-described advantages can also be obtained, however, with an embodiment of the machine according to the invention illustrated in the sequence of FIGS. 8A to 8M. In these figures, identical or equivalent parts to those described previously are indicated using the same reference numbers.

The sequence in FIGS. 8A-8M does not show the elements for detaching the trims from the members 21, 23, which can be designed as described above with reference to FIGS. 6A-6K and 7A-7F.

The sequence of FIGS. 8A-8M shows the operation of the machine in a modified embodiment similar to the one illustrated in FIGS. 2A-2F. The difference in the embodiment of FIG. 8A-8M lies in that the log feed channel is much shorter and, the movable transfer member 31 is arranged directly downstream from the cutting station 11, and downstream of the transfer member the unloading conveyor 29 is arranged. Instead of the feed conveyor 27, a simple sliding plane 27X can be provided, for instance. As can be easily appreciated from the sequence of FIGS. 8A-8M, the front engaging member 23 engages with the log during the cutting of the log L up until at least the front trim RT has been generated, and possibly up until the first roll R has been cut (FIGS. 8D and 8E). Thereafter (FIG. 8F), the front engaging member 23 is moved away from the log L, carrying the front trim RT with it. The movable transfer member 31 is withdrawn (FIG. 8G) to enable the passage of the front engaging member 23 from its forward travel along the log feed channel towards the return path underneath.

As soon as the front engaging member has passed under the logs and rolls forward feed plane (FIG. 8I), the movable transfer member 31 can return to its working position to enable the transfer of the rolls R towards the unloading conveyor 29. The next figures, from 8J to 8M show the next stages for cutting the log into rolls R, according to a method substantially equivalent to the one described above.

With this embodiment, the machine is shorter because the cutting station 11 can be arranged directly near the movable transfer member 31 and the unloading conveyor 29. This preserves the advantage of engaging the front end of the log L during the cutting of the front trim RT, as well as all the advantages relating to the removal of the front and rear trims directly downstream from the cutting station 11 without the need for a further trims eliminator member along the processing line. On the other hand, the advantage of controlling the forward feed of the log L and thereby preventing any accidental uncontrolled forward displacement due to inertia is lost.

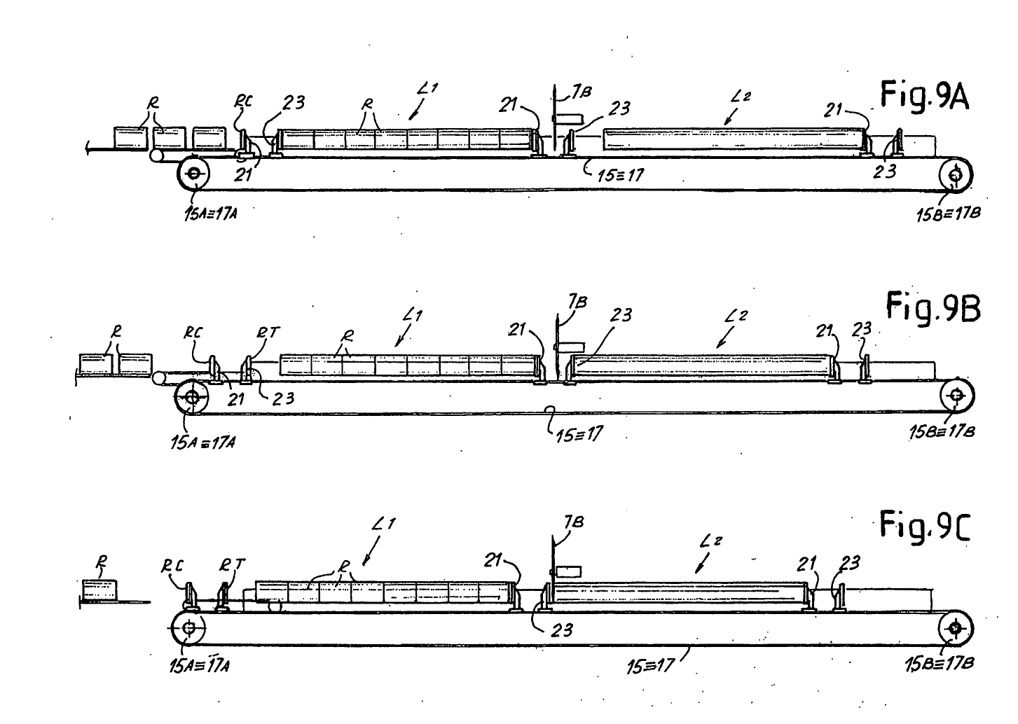

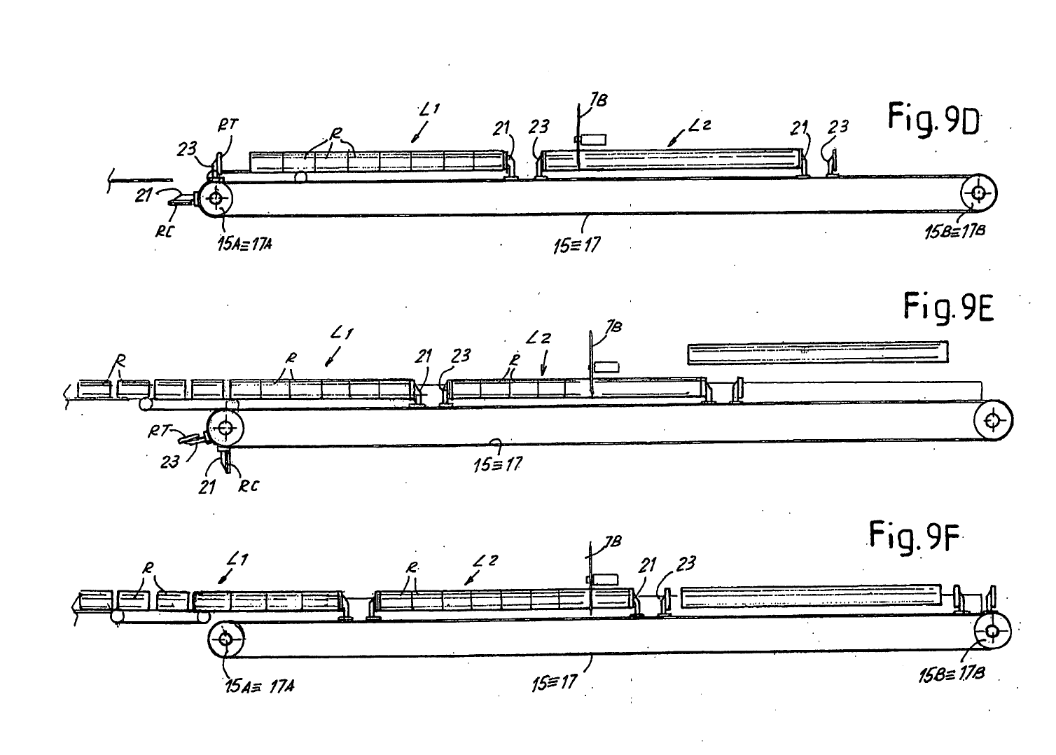

FIGS. 9A-9F show a sequence of operations of a cutting machine according to the invention in a further embodiment, similar to the one shown in FIGS. 2A-2F. The same reference numbers are used to indicate the same or equivalent parts to those of the previous embodiments.

The difference between the embodiment of FIGS. 2A-2F and the embodiment of FIGS. 9A-9F consists in the way in which the individual rear pushing and front engaging members 21, 23 are connected to the continuous flexible members 15 and 17 placed side-by-side and parallel to one another (FIG. 3). More in particular, in the previous embodiment all the rear pushing members 21 are connected to one of the continuous flexible members and all the front engaging members 23 are connected to the other of the two continuous flexible members. Vice versa, in the embodiment of FIGS. 9A-9F the arrangement is as follows: the rear pushing and front engaging members are arranged in adjacent pairs, wherein each pair is formed by a front engaging member 23 located immediately upstream (with respect to the feed direction along the path defined by the continuous members 15, 17) from a corresponding rear pushing member 21 and the distance between them remains fixed. The rear pushing members 21 and the front engaging members 23 of each of said pairs are connected to the same continuous flexible member and one of two consecutive pairs of members 21, 23 is connected to either one of the continuous flexible members 15, 17, while the other is connected to the other one of the continuous flexible members 15, 17.

As in the previous case, here again, the distance between a rear pushing member 21 and a corresponding front engaging member 23 downstream (that between them define a space for containing a log L can vary, but in this case said distance between the two is variable due to the effect of a variation in the reciprocal distance between consecutive pairs formed by opposite rear pushing and front engaging members 21, 23.

The operation appears clear from an analysis of the sequence shown in FIGS. 9A-9F, where only the upper branch of the continuous flexible members 15, 17 is shown for the sake of simplicity. It is important to note, however, that along the lower branch (not shown) of said continuous flexible members there are other rear pushing and front engaging members 21, 23.

FIG. 9A shows three pairs 21, 23 along the upper branch of the continuous flexible members 15, 17, each pair formed by a rear pushing member 21 and a front engaging member 23 immediately upstream therefrom and intended to cooperate with two successive logs. Again with reference to FIG. 9A, there are two logs, indicated as L1 and L2; the log L1 has already been completely divided into a plurality of rolls R, while the log L2 is still intact and upstream from the cutting station 11. The log L1, or rather the rolls R obtained by cutting said log, are held in a receiving space defined between the front engaging member 23 further downstream along the forward feed path of the logs, and the following rear pushing member 21, said two members being at a reciprocal distance approximately corresponding to the length of the log L1. The second log L2 is between the third rear pushing member 21 (counting from the left in the figure) and the second front engaging member 23 (again counting from the left in the figure), which are at a reciprocal distance greater than the axial length of the log L2 and therefore also greater than the axial length of the log L1.

The rear pushing and front engaging members 21, 23 forming the pair downstream from the log L1 are connected, for instance, to the continuous flexible member 15. The rear pushing and front engaging members 21, 23 upstream (with respect to the feed direction) from the log L2 are also connected to the latter, so that the reciprocal distance between the members 21, 23 of each pair and the reciprocal distance between the two pairs does not vary. Vice versa, the pair formed by the rear pushing member 21 (engaged to the log L1) and the corresponding front engaging member 23 opposite and upstream therefrom (engaged to the log L2) are connected to the other continuous flexible member, e.g. to the continuous flexible member 17. Varying the reciprocal position of the two continuous flexible members 15, 17 thus varies the reciprocal distance between consecutive pairs of members 21, 23, as can be seen by comparing FIGS. 9A and 9B.

In FIG. 9B, in fact, the central pair of members 21, 23, coming between the logs L1 and L2, has stayed still in relation to the position occupied in FIG. 9A, while the two pairs 21, 23 upstream from the log L2 and downstream from the log L1 have advanced. As a consequence, the space for receiving the log L1 has become wider, while the space for receiving the log L2 has become narrower, thereby holding the log L2 at its two ends.

The subsequent sequence in FIGS. 9C-9F of the operation of the cutting machine in this embodiment is self-explanatory.

This arrangement enables a more effective and more straightforward control and synchronization of the machine.

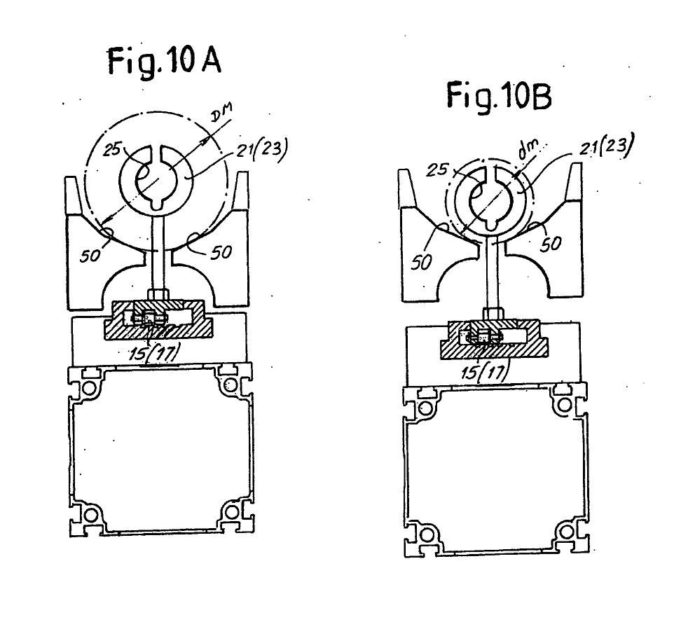

The cutting machine according to the invention can be adapted to vary the diametral dimension of the logs L to be cut. Since it is necessary for the retaining elements 25 to remain always substantially coaxial to the winding cores of the logs L, and since the height at which these winding cores are located varies as the diametral dimension of the logs L varies, in an advantageous embodiment the log feed channel L remains at a fixed height with respect to the floor on which the machine is attached, while the height of the continuous flexible members 15 and 17, and consequently of the front engaging members 23 and rear pushing members 21, is variable. The method for adjusting the reciprocal distance between the log L feed channels and the continuous flexible members 15, 17 is shown in FIGS. 10A and 10B. FIG. 10A shows a cross-sectional view of the feed channel for the log L when the machine is adjusted to process logs L of wider diameter DM, while FIG. 10B shows the same cross-sectional view with the machine adjusted to process logs of narrower diameter dm.

The cross-sectional views of FIGS. 10A and 10B also show an embodiment of the feed channel for the log L, which can be made of shaped sheets or side walls for supporting the logs L and the rolls R obtained by cutting them. Between the two sheets, indicated by the numeral 50, a longitudinal slot is provided, through which the rear pushing members 21 and the front engaging members 23 can pass.

All the above description is given on the understanding that the drawings merely give an example of a practical application of the invention, which can vary in form and arrangement without departing from the scope of the concept underlying the invention. Any reference numbers in the attached claims is merely to facilitate the reading of the claims in relation to the description and drawings, and shall not be deemed to limit the scope of the protected content of the claims in any way.

1-31. (canceled)

32. A cutting machine for cutting logs of web material into series of rolls with a front trim and a rear trim, comprising:
at least one log feed channel;
along said feed channel, a cutting station with at least one cutting blade to divide each log into individual rolls and a front trim and a rear trim;
a log feed device to feed logs along said feed channel, comprising at least one rear pushing member of the logs to be cut, moving along said feed channel to push each log through said cutting station;
wherein said feed device comprises at least one front log engaging member of the logs to be cut adapted to frontally engage each log or series of rolls obtained by cutting the log, for at least a portion of movement along said feed channel.

33. The cutting machine as claimed in claim 32, wherein said at least one front engaging member and said at least one rear pushing member are each provided with a retaining element for the front trim and the rear trim which are cut from each log, the retaining element being arranged to penetrate axial holes of said logs.

34. The cutting machine as claimed in claim 33, wherein said retaining element is expansible.

35. The cutting machine as claimed in claim 33, further comprising an element for removing the front trim, the rear trim, or the front trim and the rear trim, from a respective one of said retaining element.

36. The cutting machine as claimed in claim 32, wherein said at least one front engaging member and said at least one rear pushing member are movable along a closed path including an advancement section for movement in a common direction with a direction of feed of the logs in the feed channel, and a return section for movement in a direction opposite to the direction of feed of the logs in the feed channel.

37. The cutting machine as claimed in claim 36, wherein removal means to remove the front trim and the rear trim from the front engaging member and/or from the rear pushing member, respectively, are arranged along said return section.

38. The cutting machine as claimed in claim 36, wherein separating means for separating web material of the front trim and the rear trim from a ring formed by cutting a winding core of the logs are arranged along said return section.

39. The cutting machine as claimed in claim 38, wherein said separating means comprise a blade arranged to cut wound turns of web material without cutting said ring.

40. The cutting machine as claimed in claim 39, further comprising a suction system to remove the wound turns of web material cut by said blade.

41. The cutting machine as claimed in claim 32, further comprising, for each feed channel, a plurality of front engaging members and a plurality of rear pushing members, each front engaging member being associated with a respective rear pushing member to form therebetween respective log receiving spaces, wherein reciprocal distance between each rear pushing member and a respective front engaging member is variable to vary dimension of said log receiving spaces.

42. The cutting machine as claimed in claim 41, further comprising a first continuous flexible member and a second continuous flexible member associated with each feed channel, said first continuous flexible member and said second continuous flexible member being mutually parallel and extending along a common path; wherein rear pushing members and front engaging members are constrained to said first continuous flexible member and said second continuous flexible member, and are arranged so that, moving the first continuous flexible member and the second continuous flexible member with respect to each other causes the rear pushing members to move reciprocally away from and towards corresponding ones of the front engaging members to vary the dimension of said log receiving spaces.

43. The cutting machine as claimed in claim 42, wherein each of the front engaging members are constrained to the first continuous flexible member and each of the rear pushing members are constrained to the second continuous flexible member.

44. The cutting machine as claimed in claim 42, wherein each of the front engaging members forms a pair with a respective one of the rear pushing members immediately upstream thereof with respect to the direction of feed of said continuous flexible members; alternate pairs formed by a rear pushing member and by a front engaging member are constrained to one of said first continuous flexible member and said second continuous flexible member, alternate pairs formed by a rear pushing member and a front engaging member constrained to another of said first continuous flexible member and said second flexible member being arranged between said alternate pairs; the first continuous flexible member and said second continuous flexible member are adapted to perform reciprocal movements with respect to each other such as to cause mutual ones of said alternate-pairs of the front engaging members and the rear pushing members to move reciprocally away from and towards each other.

45. The cutting machine as claimed in claim 42, wherein said first continuous flexible member and said second continuous flexible member are controlled by respective independent motors.

46. The cutting machine as claimed in claim 42, wherein said first continuous flexible member and said second continuous flexible member each have a feed section along said feed channel and a return section extending under or at a side of said feed channel.

47. The cutting machine as claimed in claim 42, wherein said cutting station comprises a through seat through which the logs are made to pass by pushing, said seat having supporting and sliding surfaces acting on the logs that pass through said seat.

48. The cutting machine as claimed in claim 32, wherein said front engaging member and said rear pushing member are adapted to maintain each log, and the front trim and the rear trim and rolls obtained by cutting each log, gripped and engaged therebetween, making such advance through said cutting station.

49. The cutting machine as claimed in claim 48, wherein said front engaging member and said rear pushing member are adapted to move said front engaging member away from the rear pushing member after the log has been cut, to allow transfer of the rolls towards an outlet of the feed channel.

50. The cutting machine as claimed in claim 32, wherein said front engaging member is adapted to be moved away from a log being fed through the cutting station after cutting the front trim of the log.

51. The cutting machine as claimed in claim 32, wherein an unloading conveyor is arranged downstream of: said feed channel to remove the rolls obtained from cutting said logs.

52. The cutting machine as claimed in claim 51, wherein between said feed channel and said unloading conveyor a movable transfer member is arranged, which can take a first position for transferring the rolls towards said unloading conveyor and a second deactivated position, withdrawn from said feed channel, to allow the front engaging member and the rear pushing member to pass from the feed channel to a return path arranged under the feed channel.

53. The cutting machine as claimed in claim 51, wherein the feed channel extends from the cutting station towards the unloading conveyor for a length at least equal to a length of a log, said at least one front engaging member being arranged so that between the cutting station and the unloading conveyor such maintains a grip on a front trim of the log being processed, generated by the blade in the cutting station, advancing with said log and with said rolls until completion of the cut of the log into individual rolls.

54. The cutting machine as claimed in claim 51, wherein the feed channel extends from the cutting station towards the unloading conveyor for a length less than a length of a log, the front engaging member being arranged to accelerate and withdraw from the feed channel before completion of the cut of a log into individual rolls.

55. A method for dividing a log of web material into a plurality of rolls and into a front trim and a rear trim, comprising:
feeding a log along a feed channel through a cutting station by a rear pushing member;
in said cutting station dividing said log into a front trim, a series of rolls and a rear trim;
at least for a part of the feed travel of the log along said feed channel, engaging the log frontally by a front engaging member, so that the log is made to advance gripped between said rear pushing member and said front engaging member.

56. The method as claimed in claim 55, wherein said log and said rolls are held between said rear pushing member and said front engaging member entirely during feed travel through the cutting station as required to cut the front trim, the rolls and the rear trim; and after cutting the rear trim said front engaging member is accelerated and moved away from the rear pushing member, the rolls being unloaded from the feed channel.

57. The method as claimed in claim 55, wherein: said log is held between said rear pushing member and said front engaging member for a part of the feed travel through the cutting station necessary to cut at least the front trim of the log; said front engaging member being subsequently accelerated and moved away from the rear pushing member before completion of cutting of the log into individual rolls.

58. The method as claimed in claim 55, wherein the front trim is retained by said front engaging member and moved away from the first roll obtained from the dividing of said log.

59. The method as claimed in claim 58, wherein said front trim is transferred by said front engaging member under or to a side of the feed channel and is subsequently unloaded from the front engaging member.

60. The method as claimed in claim 55, wherein the rear trim is retained by said rear pushing member and moved away from the rolls obtained from the dividing of said log.

61. The method as claimed in claim 60, wherein said rear trim is transferred by said rear pushing member under or to a side of the feed channel and is subsequently unloaded from the rear pushing member.

62. The method as claimed in claim 32, wherein said front trim, or said rear trim, or said front trim and said rear trim, are divided to separate web material from a winding core after having been separated from the rolls obtained from the dividing of said log.
